(19) United States
(12) Patent Application Publication
(10) Pub. No.: US 2015/0247458 A1
(43) Pub. Date: Sep. 3, 2015

(54) BEARING SUPPORT STIFFNESS CONTROL

(71) Applicant: UNITED TECHNOLOGIES CORPORATION, Hartford,, CT (US)

(72) Inventors: Jonathan Ariel Scott, Tolland, CT (US); Alan Lees, Manchester, CT (US)

(73) Assignee: UNITED TECHNOLOGIES CORPORATION, Hartford, CT (US)

(21) Appl. No.: 14/433,730

(22) PCT Filed: Feb. 12, 2013
(86) PCT No.: PCT/US2013/025707

§ 371 Date: Apr. 6, 2015

Related U.S. Application Data
(60) Provisional application No. 61/711,423, filed on Oct. 9, 2012.

(51) Int. Cl. F02C 7/06; F02C 3/04

(52) U.S. Cl. CPC F02C 7/06; F02C 3/04

(57) ABSTRACT

A bearing support bracket for supporting the bearing assembly includes individually adjustable features for defining and enabling a desired stiffness.

### CROSS REFERENCE TO RELATED APPLICATION

This application claims priority to U.S. Provisional Application No. 61/711,423 filed on Oct. 9, 2012.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

A static structure supporting engine rotating components is required to provide a module stiffness determined to handle dynamic loads. Engine static structure components can include complex shapes that are difficult to modify to obtain desired module stiffness while maintaining structural rigidity. Engine manufacturers are continually seeking methods and features that simplify design and assembly and therefore it is desirable to develop support structures that are easily tailored to meet structural demands.

### SUMMARY

A gas turbine engine according to an exemplary embodiment of this disclosure, among other possible things includes a compressor section disposed about an axis, a combustor in fluid communication with the compressor section, a turbine section in fluid communication with the combustor, a shaft rotating about an the axis and driven by the turbine section for driving the compressor section, a bearing assembly supporting rotation of the shaft, and a bearing support supporting the bearing assembly and including an aft flange supported on an aft cone having a first length and first thickness and a support flange supported on a support cone having a second length and a second thickness defined separate from the first thickness and the first length to define a desired stiffness of the bearing assembly.

In a further embodiment of the foregoing gas turbine engine, the first length is related to the first thickness by a ratio between about 18.0 and about 22.0 to define the desired stiffness of the bearing assembly.

In a further embodiment of any of the foregoing gas turbine engines, the second length and the second thickness are related according to a ratio between about 3.0 and about 4.25 to further define the desired stiffness of the bearing assembly.

In a further embodiment of any of the foregoing gas turbine engines, the bearing support includes a body portion with the aft cone and the support cone extends from the body portion.

In a further embodiment of any of the foregoing gas turbine engines, the body portion includes a surface substantially parallel to the axis and the aft cone extends from the body portion at a first angle related to the first length according to a ratio between about 0.23 and about 0.25.

In a further embodiment of any of the foregoing gas turbine engines, the body portion includes a surface substantially parallel to the axis and the support cone extends from the body portion at a second angle related to the second length according to a ratio between about 0.130 and about 0.135.

In a further embodiment of any of the foregoing gas turbine engines, the aft flange includes a first diameter related to the first length according to a ratio between about 5.85 and about 6.15.

In a further embodiment of any of the foregoing gas turbine engines, the support flange includes a second diameter related to the second length according to a ratio between about 16.85 and about 17.15.

In a further embodiment of any of the foregoing gas turbine engines, the bearing support includes an overall length related to the first length according to a ratio between about 5.90 and 6.10.

A bearing assembly for a gas turbine engine according to an exemplary embodiment of this disclosure, among other possible things includes a bearing support including an aft flange supported on an aft cone mounted to a fixed structure of the gas turbine engine and a support flange supported on support cone, and a bearing disposed between a first race supported on the support flange and a second race fixed to a rotating shaft. The aft cone includes a first length and first thickness and the support cone includes a second length and a second thickness separately defined from the first thickness and the first length to define a desired stiffness of the bearing assembly.

In a further embodiment of the foregoing bearing assembly, the bearing support includes a body portion with the aft cone and the support cone extending from the body portion.

In a further embodiment of any of the foregoing bearing assemblies, the bearing support at least partially defines a cavity within which is supported the bearing.

In a further embodiment of any of the foregoing bearing assemblies, the body portion includes a surface substantially parallel to the axis and the aft cone extends from the body portion at an angle related to the first length according to a ratio between about 0.25 and about 0.23.

In a further embodiment of any of the foregoing bearing assemblies, the body portion includes a surface substantially parallel to the axis and the support cone extends from the body portion at an angle related to the second length according to a ratio between about 0.130 and about 0.135.

In a further embodiment of any of the foregoing bearing assemblies, the first thickness is related to the first length by a ratio between about 18.0 and about 22.0 to define further define the desired stiffness of the bearing assembly.

In a further embodiment of any of the foregoing bearing assemblies, the second length and the second thickness are related according to a ratio between about 3.0 and about 4.25 to further define the desired stiffness of the bearing assembly.

A method of defining bearing assembly stiffness for a gas turbine engine according to an exemplary embodiment of this disclosure, among other possible things includes attaching an aft flange to a fixed support structure and supporting the aft flange on an aft cone extending from a body portion a first length, attaching a bearing support member to a support flange extending from the body portion a second length less than the first length, and adjusting a first thickness of the first length of the aft cone and a second thickness of the second length of the support cone to define the desired stiffness of the bearing assembly.

In a further embodiment of the foregoing method, includes adjusting the first thickness in relation to the first length according to a ratio between about 18.0 and about 22.0, and adjusting the second thickness in relation to the second length according to a ratio between about 3.0 and about 4.25.

In a further embodiment of any of the foregoing methods, includes extending the aft cone from the body portion at first angle related to the first length according to a ratio between about 0.25 and about 0.23 and extending the support cone from the body portion at a second angle relative to the second length according to a ratio between about 0.130 and 0.135.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a schematic view of an example industrial gas turbine engine.

FIG. 3 is a cross-section of an a portion of an example gas turbine engine.

FIG. 4 is a cross-section of an example bearing support bracket.

FIG. 5 is a cross-section another example bearing support bracket.

FIG. 6 is an enlarged view of the example bearing support bracket shown in FIG. 5.

### DESCRIPTION

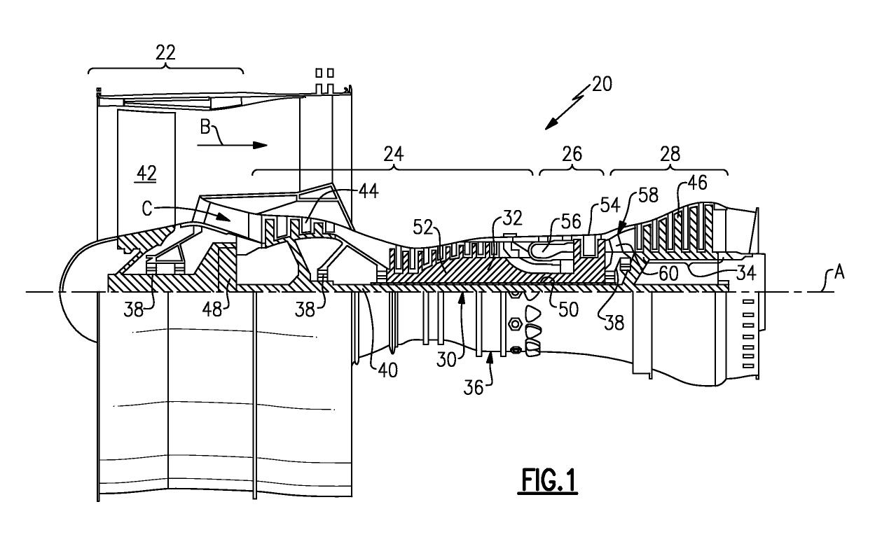

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

Airflow through the core flow path C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (1 bm) of fuel per hour being burned divided by pound-force (1 bf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/(518.7° R]^{0.5}. The “Low corrected fan tip speed”, as disclosed herein according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

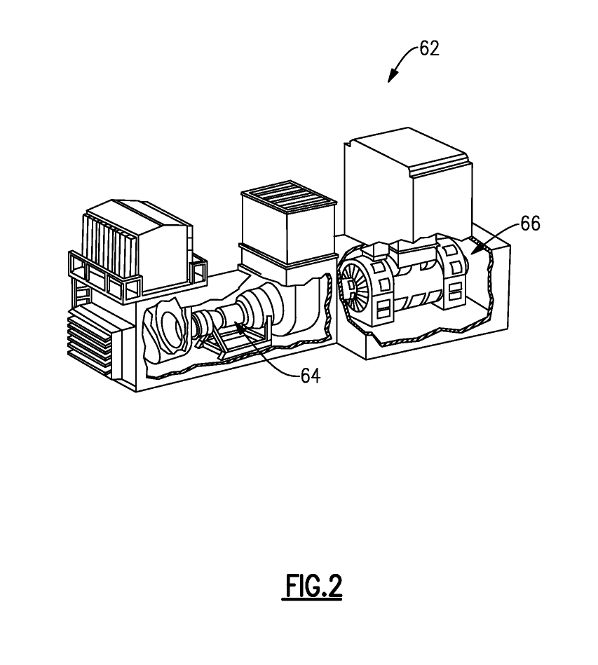

Referring to FIG. 2, an example industrial gas turbine engine assembly 62 includes a gas turbine engine 64 that is mounted to a structural land based frame to drive a generator 66. The example gas turbine engine 64 includes many of the same features described in the gas turbine engine 20 illustrated in FIG. 1 and operates in much the same way. The land based industrial gas turbine engine 62, however, may include additional features such as a shaft and/or exhaust flow path to drive the generator 66 and is not constrained by the same weight restrictions that apply to an aircraft mounted gas turbine engine. As appreciated, many of the parts that are utilized in an aircraft and land based gas turbine engine are common and therefore both aircraft based and land based gas turbine engines are within the contemplation of this disclosure.

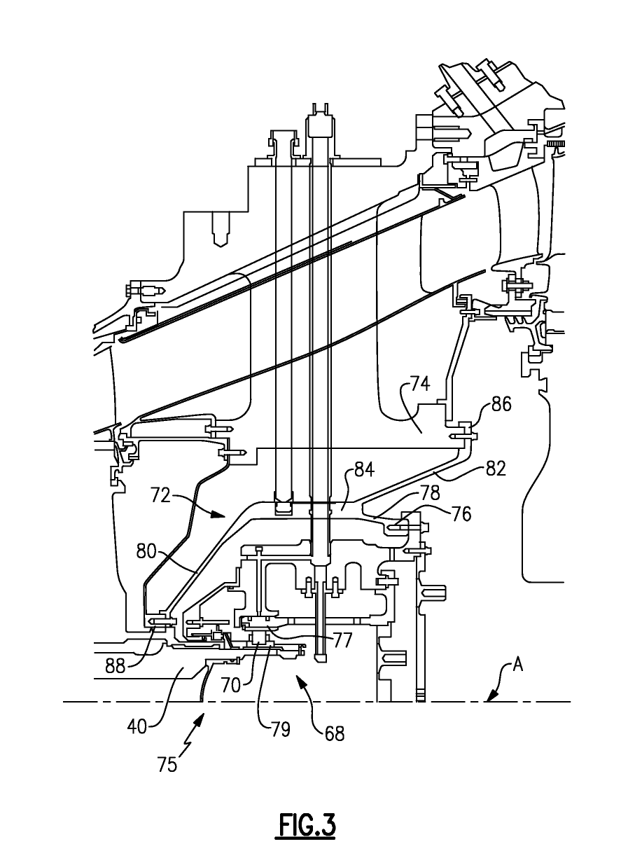

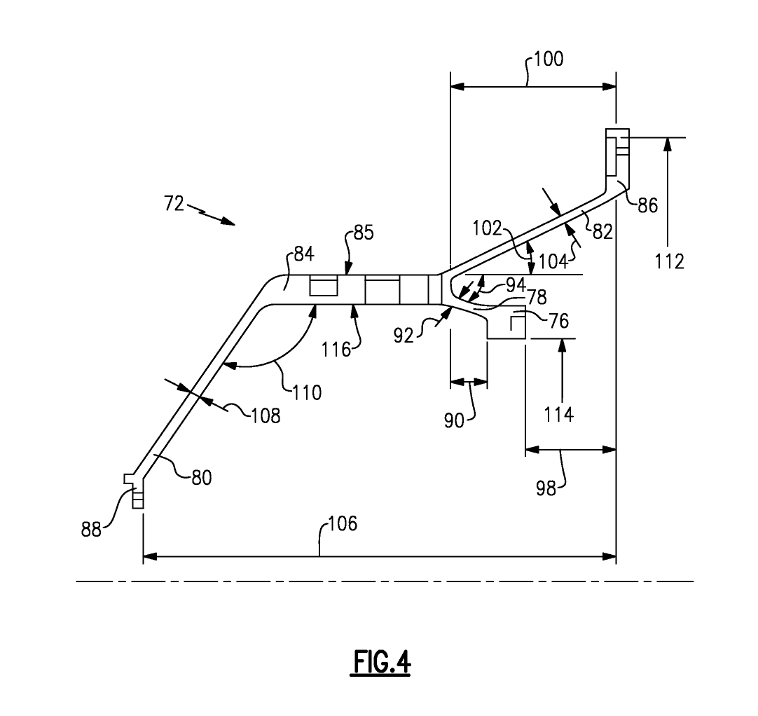

Referring to FIGS. 3 and 4, with continued reference to FIGS. 1 and 2, a bearing assembly 75 supports rotation of an aft portion of the low pressure turbine shaft 40. The bearing assembly 75 includes a roller bearing 70 disposed within a bearing compartment 68 defined within a bearing support bracket 72. The roller bearing 70 is supported between a first race 77 and a second race 79. The first race 77 is attached to the support bracket 72 and the second race 79 is supported on the shaft 40. The bearing support bracket 72 is attached to a portion of the engine static structure 74.

A desired module stiffness is utilized that enable an engine to handle dynamic loads such as rotation of the shaft 40. The stiffness of the bearing 70 supporting rotation of the shaft 40 results from the structure supporting the bearing 70. The example bearing support bracket 72 includes features for tailoring support of the bearing 70 to provide the desired structural required for supporting rotation of the shaft 40.

The bearing support bracket 72 includes a body portion 84 defining a surface 85 substantially parallel to the axis A. An aft cone 82 extends radially outward and aft of the body portion 84 and supports an aft flange 86 spaced axially apart from the body portion 84.

A support cone 78 also extends aft of the body portion 84 to support a support flange 76. The aft flange 86 is attached to the static structure 74 and the first race 77 is attached to the support flange 76. The support bracket 72 includes a forward cone 80 that extends forward of the body portion 84 and is angled according to angle 110 radially inward toward the axis A to support a forward flange 88. The forward cone 80 can be adjusted to change the stiffness of the part and to provide for a desired path for a secondary airflow.

The figures illustrate a cross section of the bearing support bracket 72 about the axis A. Accordingly, the features of the support bracket 72 shown in cross-section represent annular structures about the axis A. Each structure and portion of the bearing support 72 is tunable to tailor module stiffness to provide the desired engine dynamics.

The aft cone 82 includes a first length 100, a first thickness 104 and is disposed at a first angle 102 relative to the surface 85 of the body portion 84. Each of the first length 100, first thickness 104 and first angle 102 are tunable to enable adjustment of the stiffness of the roller bearing 70. Moreover, the stiffness of the aft cone 82 is separately adjustable from the support cone 78 to further enable adjustment of module stiffness supporting the bearing 70.

In one disclosed example embodiment, the aft cone 82 provides a desired stiffness by including a ratio of the first length 100 to the first thickness 104 that is between about 18.0 and about 22.0. Another tunable feature is represented in a ratio of an overall length 106 as it relates to the length 100 that is between about 2.50 and about 3.50.

Moreover, the aft cone 82 may be further tailored to provide a desired stiffness by modification of the first angle 102. In one example disclosed embodiment, the first length 100 is related to the first angle 102 according to a ratio between about 0.23 and about 0.25.

The support cone 78 further includes tunable features that are defined separate from the first thickness 104, first length 100 and first angle 102 of the aft cone 82. The support cone 78 includes a second length 90, a second thickness 92, and a second angle 94 that are tunable to enable adjustment of the stiffness of the roller bearing 70 in support of the shaft 40. In one disclosed example embodiment the tunable features of the support cone 78 are defined as a ratio of the second arm length 90 to the second thickness 92 that is between about 3.0 and 4.25.

The support cone 78 extends from the body portion at the second angle 94 that provides a further tunable feature to define the overall structural stiffness encountered by the bearing 70 that is provided to support the shaft 40. In one disclosed embodiment, the second angle 94 is defined according to a relationship to the second length 90 to provide a desired stiffness according to a ratio between about 0.130 and about 0.135.

It should be understood that each of the aft cone 82, arm 78 and forward cone 80 can be tuned separately or in concert with each other to provide the desired overall module stiffness of the support bracket 72 and thereby support of the shaft 40.

The example bearing support 72 includes an aft diameter 112 that corresponds to the aft flange 86 and a mount diameter 114 that corresponds to the support flange 76. The example aft diameter 112 is provided in relation to the first length 100 to enable a desired stiffness according to a ratio of the first diameter 112 and the first length 100 that is between about 5.85 and about 6.15.

The support flange 76 is disposed at a second diameter 114. The example support flange 76 is defined to provide a desired stiffness at least partially by providing a relationship between the second length 90 and the second diameter according to a ratio between about 16.85 and about 17.15. The example bearing support 72 further defines the overall desired thickness at least in part by providing the first length 100 as a portion of the overall length 106 according to a ratio between about 5.90 and 6.10.

A load path is defined from the bearing assembly 75 from the support flange 76 through to the aft flange 86. The support flange 76 is the anchor point and stiffness can be tuned by adjusting the lengths 98 and 100.

A further dimensional embodiment that defines an example desired overall stiffness of the bracket 72 relates the first diameter 112 to the second diameter 114. As appreciated, the relationship between the first diameter 112 and the second diameter 114 provides the bracket with a desired range of stiffness to support and balance operational requirements of supporting the shaft 40. In one example embodiment this relationship is defined by a ratio of the first diameter 112 to the second diameter that is within a range of between about 1.4 and about 1.90. It should be understood that each feature of the example bearing support is tunable in concert with other features to provide and tailor an overall stiffness.

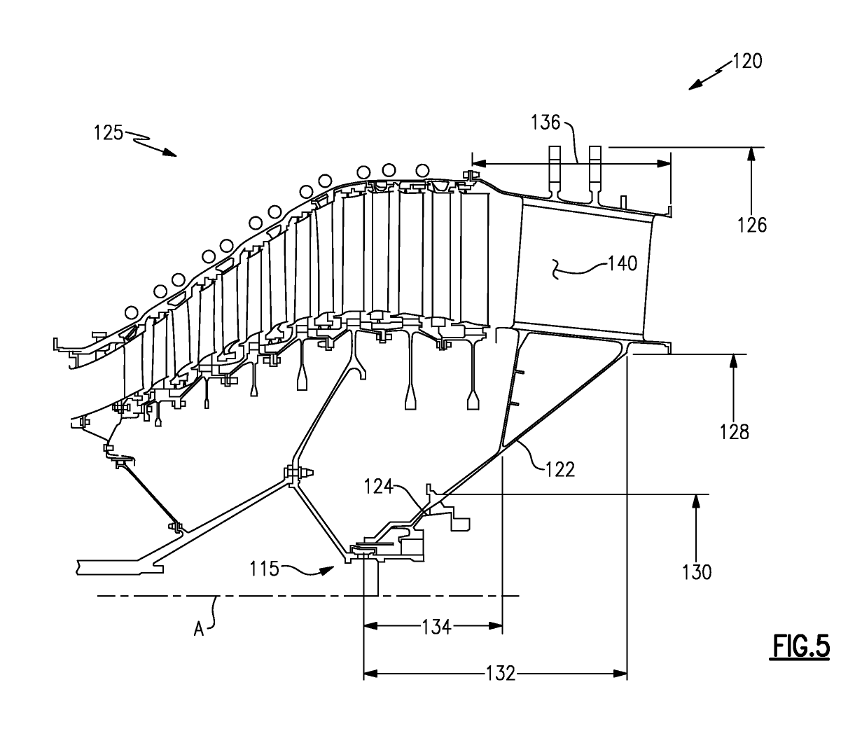

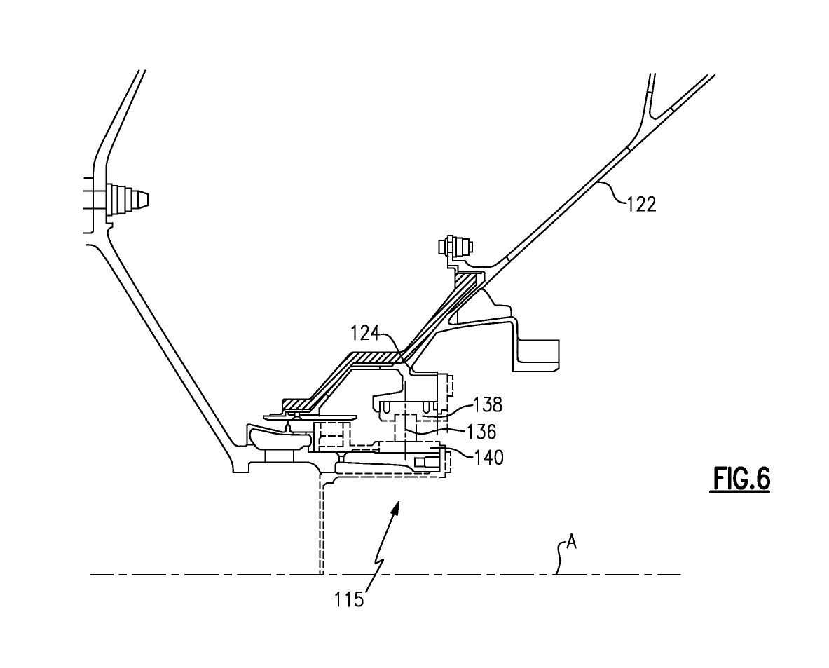

Referring to FIGS. 5 and 6, another example bearing assembly 115 is disclosed and supported by a support bracket 124 disposed at an aft portion 120 of a turbine section 125. The support bracket 124 is an integral portion of the exhaust case 122. In this example the bracket 124 and case 122 include tunable features to adjust overall module stiffness of the bearing assembly 115. The example bearing assembly 115 includes a roller bearing 138 supported between an outer race 138 attached to the support bracket 124 and an inner race 140 supported on a rotating part of the turbine section 125.

In the disclosed example an outermost diameter 126 is defined at an outer flange of the exhaust case 122. An intermediate diameter 128 is defined at an inner surface of the exhaust gas flow path 140 and is related to a first length 132. The first length 132 extends from a forward most end of the support bracket 124 to an aft end of the exhaust case 122. The stiffness at the bearing assembly is determined as a factor of the tunable features defined in the support bracket 124 and exhaust case 122. In this example, the stiffness is provided in the support bracket 124 according to a relationship between the diameter 128 and the length 132. In one disclosed example, a ratio of the diameter 128 to the length 132 is between about 1.7 and about 2.0. Another diameter 130 is defined at a length 134 from the forward portion of the support bracket 124 and is a further tunable feature. In this example a ratio of the diameter 130 to the length 134 is between about 1.25 and 1.75.

Accordingly, the example support brackets include individually tunable features that are adjustable in combination and/or separately to enable a specific stiffness required to support bearing assemblies and thereby rotating engine components.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A gas turbine engine comprising:
a compressor section disposed about an axis;
a combustor in fluid communication with the compressor section;
a turbine section in fluid communication with the combustor;
a shaft rotating about an the axis and driven by the turbine section for driving the compressor section;
a bearing assembly supporting rotation of the shaft; and
a bearing support supporting the bearing assembly and including an aft flange supported on an aft cone having a first length and first thickness and a support flange supported on a support cone having a second length and a second thickness defined separate from the first thickness and the first length to define a desired stiffness of the bearing assembly.

2. The gas turbine engine as recited in claim 1, wherein the first length is related to the first thickness by a ratio between about 18.0 and about 22.0 to define the desired stiffness of the bearing assembly.

3. The gas turbine engine as recited in claim 1, wherein the second length and the second thickness are related according to a ratio between about 3.0 and about 4.25 to further define the desired stiffness of the bearing assembly.

4. The gas turbine engine as recited in claim 1, wherein the bearing support includes a body portion with the aft cone and the support cone extending from the body portion.

5. The gas turbine engine as recited in claim 4, wherein the body portion includes a surface substantially parallel to the axis and the aft cone extends from the body portion at a first angle related to the first length according to a ratio between about 0.23 and about 0.25.

6. The gas turbine engine as recited in claim 4, wherein the body portion includes a surface substantially parallel to the axis and the support cone extends from the body portion at a second angle related to the second length according to a ratio between about 0.130 and about 0.135.

7. The gas turbine engine as recited in claim 1, wherein the aft flange includes a first diameter related to the first length according to a ratio between about 5.85 and about 6.15.

8. The gas turbine engine as recited in claim 2, wherein the support flange includes a second diameter related to the second length according to a ratio between about 16.85 and about 17.15.

9. The gas turbine engine as recited in claim 1, wherein the bearing support includes an overall length related to the first length according to a ratio between about 5.90 and 6.10.

10. A bearing assembly for a gas turbine engine comprising:
a bearing support including an aft flange supported on an aft cone mounted to a fixed structure of the gas turbine engine and a support flange supported on support cone; and
a bearing disposed between a first race supported on the support flange and a second race fixed to a rotating shaft, wherein the aft cone includes a first length and first thickness and the support cone includes a second length and a second thickness separately defined from the first thickness and the first length to define a desired stiffness of the bearing assembly.

11. The bearing assembly as recited in claim 10, wherein the bearing support includes a body portion with the aft cone and the support cone extending from the body portion.

12. The bearing assembly as recited in claim 10, wherein the bearing support at least partially defines a cavity within which is supported the bearing.

13. The bearing assembly as recited in claim 11, wherein the body portion includes a surface substantially parallel to the axis and the aft cone extends from the body portion at an angle related to the first length according to a ratio between about 0.25 and about 0.23.

14. The bearing assembly as recited in claim 11, wherein the body portion includes a surface substantially parallel to the axis and the support cone extends from the body portion at an angle related to the second length according to a ratio between about 0.130 and about 0.135.

15. The bearing assembly as recited in claim 10, wherein the first thickness is related to the first length by a ratio between about 18.0 and about 22.0 to define further define the desired stiffness of the bearing assembly.

16. The bearing assembly as recited in claim 10, wherein the second length and the second thickness are related according to a ratio between about 3.0 and about 4.25 to further define the desired stiffness of the bearing assembly.

17. A method of defining bearing assembly stiffness for a gas turbine engine comprising:
attaching an aft flange to a fixed support structure and supporting the aft flange on an aft cone extending from a body portion a first length;
attaching a bearing support member to a support flange extending from the body portion a second length less than the first length; and
adjusting a first thickness of the first length of the aft cone and a second thickness of the second length of the support cone to define the desired stiffness of the bearing assembly.

18. The method as recited in claim 17, including adjusting the first thickness in relation to the first length according to a ratio between about 18.0 and about 22.0, and adjusting the second thickness in relation to the second length according to a ratio between about 3.0 and about 4.25.

19. The method as recited in claim 17, including extending the aft cone from the body portion at first angle related to the first length according to a ratio between about 0.25 and about 0.23 and extending the support cone from the body portion at a second angle relative to the second length according to a ratio between about 0.130 and 0.135.
